(19) United States
(12) Patent Application Publication
(10) Pub. No.: US 2021/0267194 A1
(43) Pub. Date: Sep. 2, 2021

(54) SEED TREATMENT METHOD

(71) Applicant: Bayer CropScience LP, St. Louis, MO (US)

(72) Inventors: Anjan DAS, Cary, NC (US); Samuel Terry GOUGE, Chesterfield, MO (US); Milind SINGH, Apex, NC (US)

(21) Appl. No.: 17/255,799

(22) PCT Filed: Jun. 20, 2019
(86) PCT No.: PCT/US2019/038126

§ 371 Date: Dec. 23, 2020

Related U.S. Application Data
(60) Provisional application No. 62/689,381, filed on Jun. 25, 2018.

(51) Int. Cl. A01N 25/04; A01N 25/30; A01N 43/40; A01C 1/06

(52) U.S. Cl. CPC A01N 25/04; A01C 1/06; A01N 43/40; A01N 25/30

(57) ABSTRACT

The present invention provides a method of increasing the concentration of an active ingredient in an agrochemical formulation while maintaining the flowability of the agrochemical formulation. The present invention also provides an agrochemical formulation produced by the disclosed methods and plant propagation material treated with the agrochemical formulation.

### TECHNICAL FIELD

The invention relates to methods of producing highly concentrated, flowable agrochemical formulations, to the resulting formulations, and to plant propagation material treated with these formulations.

### BACKGROUND

Agrochemical formulations are commonly supplied to the end user as a concentrate which is then diluted for use. Adjuvant and agrochemical actives can be added in the tank mix at the point of dilution. However, preferably the adjuvants and actives are included in the concentrate. When the agrochemical active ingredient is insoluble or only partly soluble in water, the concentrate comprising the active is conveniently supplied in the form of a suspension concentrate (SC) in which finely divided solid particles of agrochemical are suspended in an aqueous formulation. Wetting agents and dispersants may also be including in the SC to wet and stabilize the solid particles. SC formulations may therefore typically comprise a solid active, surfactant, density/viscosity modifier system, freeze/thaw additive, bactericide, anti-foamer, and water diluent.

It is important that the solid particles remain suspended in the concentrate formulation without significant separation over an extended period of time under typical storage conditions. It is also important to prevent the dispersed solid particles in the SC from forming a hard pack sediment upon storage. It is therefore normally necessary to incorporate suspending or structuring agents in to the suspension concentrate. For example, existing structuring agents used for water-based SCs include polysaccharide gums, clays, celluloses, polyacrylates, and xantham gum.

The presence of high loadings of agrochemicals in an SC formulation with consequent reduction in water content present the formulator with major problems including challenges in maintaining the SC formulation in a flowable form. The flowability of the formulation is particularly important for seed treatment formulations, which are typically applied with equipment that pumps the formulations onto the seed.

Therefore, there is a need for methods of producing agrochemical formulations with high concentrations of active ingredients without negatively affecting the finished product viscosity, and which are able to maintain solid active ingredient in suspension for a period of time to allow for storage without breakdown of the suspension.

### SUMMARY

In some embodiments, the present invention is directed to a method of increasing the concentration of an active ingredient in an agrochemical formulation while maintaining the flowability of the agrochemical formulation, the method comprising: i) combining a portion of the active ingredient with a surfactant in water to produce a mixture; ii) milling the mixture until the particle size of the active ingredient in the mixture is reduced to less than about 100 micrometers; and iii) adding more of the active ingredient and, optionally, more of the surfactant to the mixture and repeating steps i) and ii).

In certain aspects, step iii) is performed and, optionally, repeated to achieve successively smaller particle sizes with the active ingredient in the mixture. In other aspects, in step ii) the mixture is milled until the particle size of the active ingredient in the mixture is reduced to between about 20 micrometers and about 80 micrometers. In yet other aspects, in step iii) the mixture is milled until the particle size of the active ingredient in the mixture is reduced to less than about 15 micrometers. In one aspect, in step iii) the mixture is milled until the particle size of the active ingredient in the mixture is reduced to between about 1 micrometers and about 10 micrometers.

In other embodiments, the active ingredient has a density of between about 1.0 and about 2.0 g/mL. In one aspect, the active ingredient has a melting point above about 50° C. In yet other embodiments, the active ingredient has a solubility in water of less than about 1000 mg/L.

In certain aspects, the milling is performed by fluid energy milling, ball milling, wet milling, media milling, high pressure homogenization, or cryogenic milling. In one aspect, the milling is carried out with a media mill, a colloid mill, a planetary mill, a stirred annular mill, a stirred pin mill, a stone mill, a bead mill, or a perforated disc mill. In another aspect, the milling occurs in a mill with a controlled temperature set between about PC and about 60° C.

In some embodiments, the concentration of the active ingredient in the agrochemical formulation is increased to above 500 g/L. In other embodiments, the viscosity of the agrochemical formulation is maintained below 2000 centipoise. In one aspect, the viscosity of the agrochemical formulation is maintained between about 400 centipoise and about 1000 centipoise.

In certain aspects, the agrochemical formulation is a seed treatment formulation.

In some embodiments, the active ingredient is an insecticide selected from the group consisting of abamectin, chlorantraniliprole, clothianidin, cyantraniliprole, ethiprole, fipronil, flubendiamide, flupyradifurone, imidacloprid, methiocarb, spinetoram, spinosad, sulfoxaflor, tefluthrin, thiacloprid, thiamethoxam, and thiodicarb.

In other embodiments, the active ingredient is a fungicide selected from the group consisting of azoxystrobin, beta-cyfluthrin, carbendazim, carbendazim, cyproconazole, epoxiconazole, fenamidone, fluazinam, fludioxinil, fluopyram, fluoxastrobin, fluquinconazole, ipconazole, iprodione, isotianil, metalaxyl, metalaxyl-M, metominostrobin, pencycuron, penflufen, picarbutrazox, picoxystrobin, procymidone, propiconazole, prothioconazole, pyraclostrobin, tebuconazole, triadimenol, and trifloxystrobin.

In one embodiment, the active ingredient is fluopyram. In another embodiment, the active ingredient is a triazole fungicide or a strobilurin fungicide.

In certain aspects, the disclosed method further comprises determining the concentration of the active ingredient in the agrochemical formulation after milling the mixture in step ii) and/or in step iii).

In other aspects, the surfactant is a nonionic surfactant or an anionic surfactant. In one aspect, the nonionic surfactant is an alkoxylate surfactant or a polymeric surfactant. In one embodiment, the alkoxylate surfactant is an alcohol, alkylphenol, amine, amide, arylphenol, fatty acid or fatty acid ester; and the alkoxylate surfactant has been alkoxylated with 1 to 50 equivalents. In another embodiment, the polymeric surfactant is a block polymer of the A-B or A-B-A type comprising blocks of polyethylene oxide and polypropylene oxide or of the A-B-C type comprising alkanol, polyethylene oxide and polypropylene oxide.

In other aspects, the polymeric surfactant is a poloxamer or an acrylic copolymer. In yet other aspects, the anionic surfactant is a sulfonate or a carboxylate. In one embodiment, the sulfonate is a lignin sulfonate, a sulfonate of condensed naphthalenes, or a salt thereof. In another embodiment, the carboxylate is an alkyl carboxylate, an alkylphenol ethoxylate, a polycarboxylic acid, or a carboxylated alcohol.

In some aspects, the present invention is directed to an agrochemical formulation produced by the methods disclosed herein. In one aspect, the active ingredient in the agrochemical formulation is fluopyram.

In other embodiments, the present invention provides propagation material treated with an agrochemical formulation disclosed herein. In certain aspects, the propagation material is a seed of corn, soybean, rice, cotton, sugar beet, oil seed rape, sorghum, oat, rye, barley, wheat, sunflower, or a vegetable. In one aspect, the propagation material is a soybean seed.

### BRIEF DESCRIPTION OF THE DRAWINGS

FIG. 1 depicts a weight ratio of the active ingredient, fluopyram, to water of approximately 2:1 for a seed treatment agrochemical formulation. Increasing this ratio to produce a more highly concentrated formulation allows the addition of other active ingredients to the seed treatment agrochemical formulation. However, as this ratio increases the viscosity increases and the flowability decreases.

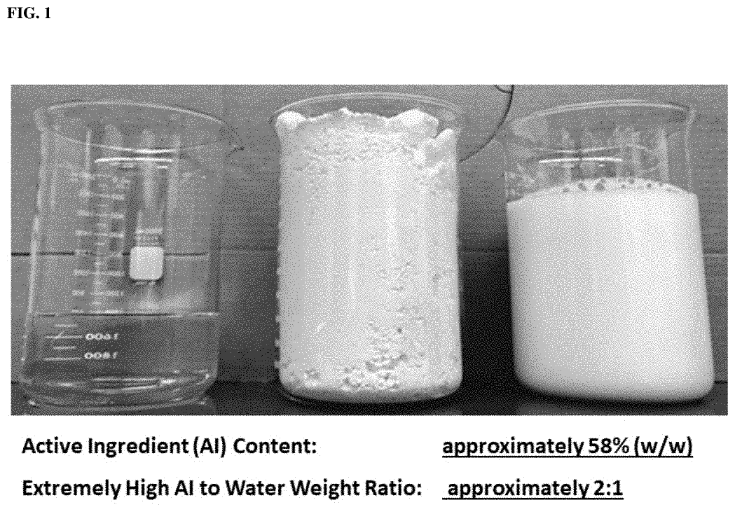

FIG. 2A depicts the flowability of a concentrated formulation of fluopyram made without the processing steps disclosed herein. The high levels of active ingredient significantly increase the viscosity of the formulation.

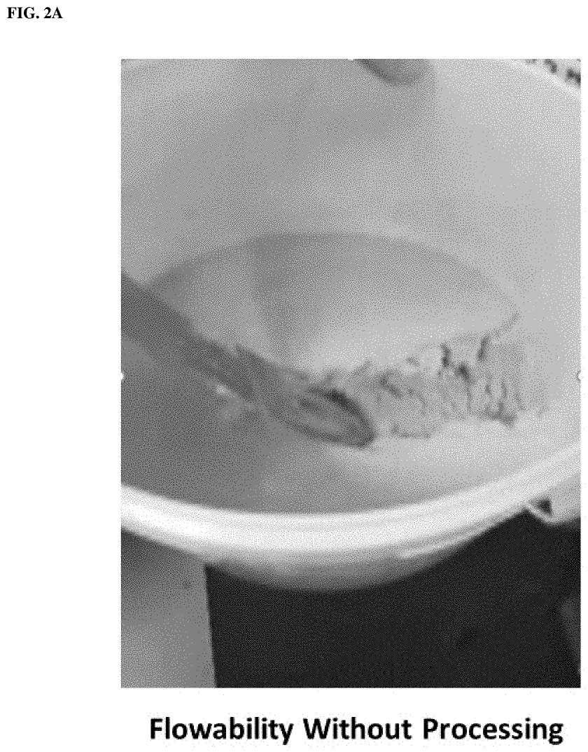

FIG. 2B depicts the flowability of a concentrated formulation of fluopyram made with the processing steps disclosed herein. The processing steps maintain the flowability of the formulation and keep the viscosity of the formulation below 2000 centipoise.

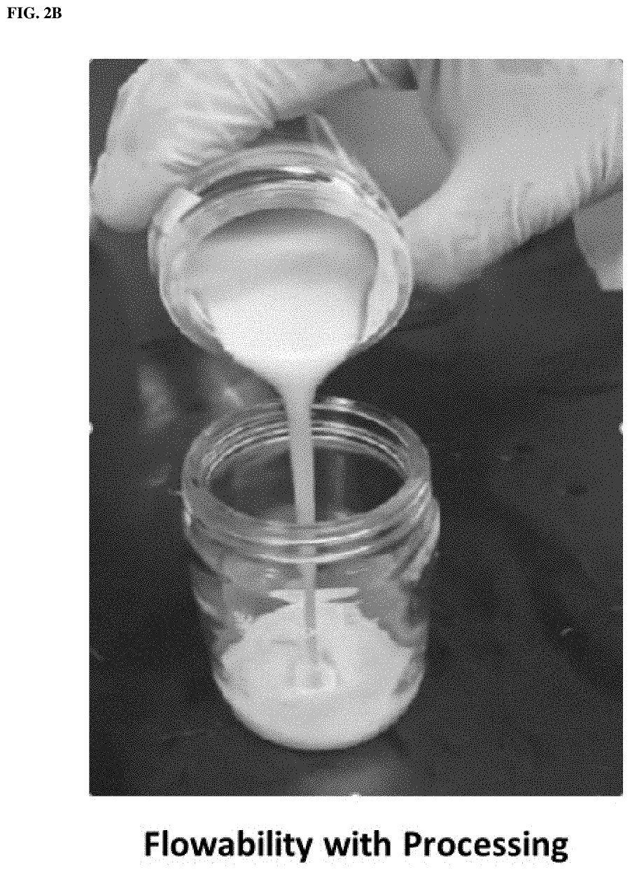

### DETAILED DESCRIPTION

As used herein, the verb “comprise” as is used in this description and in the claims and its conjugations are used in its non-limiting sense to mean that items following the word are included, but items not specifically mentioned are not excluded. In addition, reference to an element by the indefinite article “a” or “an” does not exclude the possibility that more than one of the elements are present, unless the context clearly requires that there is one and only one of the elements. The indefinite article “a” or “an” thus usually means “at least one”.

Other than in the operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

In addition, it should be understood that any numerical range recited herein is intended to include all sub-ranges subsumed therein. For example, a range of 1 to 10 is intended to include all sub-ranges between and including the recited minimum value of 1 and the recited maximum value of 10, that is, having a minimum value equal to or greater than 1 and a maximum value of equal to or less than 10.

In some embodiments, the present invention is directed to a method comprising the milling of a mixture containing an active ingredient and a surfactant. Various techniques can be used to perform the milling including those explained in Nakach et al., Journal of Pharmaceutical Sciences 106 (2017) 1889-1904 and in Loh et al., Asian Journal of Pharmaceutical Sciences 10 (2015) 255-274.

In certain aspects, the equipment used to carry out the milling is a planetary mill, a stirred annular mill (e.g., NANOMILL® 01), or a stirred pin mill (e.g., LABSTAR® or LMZ2®). In other aspects, the equipment used to carry out the milling is a stone mill, a bead mill, a perforated disc mill, or a colloid mill. In one aspect, the equipment used to carry out the milling is an annular gap bead mill. In another aspect, the equipment used to carry out the milling is a toothed colloid mill. In yet another aspect, the equipment used to carry out the milling is a corundum stone mill.

The mills used to perform the methods disclosed herein may be horizontal (e.g., a horizontal media mill or a horizontal bead mill) or vertical (e.g., a vertical media mill or a vertical bead mill).

Various milling techniques may be used to mill the mixture containing an active ingredient and a surfactant. These techniques include but are not limited to fluid energy milling, ball milling, wet milling, media milling, high pressure homogenization, and cryogenic milling. See Loh et al., Asian Journal of Pharmaceutical Sciences 10 (2015) 255-274. Additionally, shearing with the milling surfaces of a rotor and stator in a colloid mill may be used to mill the mixture containing the active ingredient and surfactant.

In some embodiments, the present invention relates to a method of increasing the concentration of an active ingredient in an agrochemical formulation while maintaining the flowability of the agrochemical formulation, the method comprising: i) combining a portion of the active ingredient with a surfactant in water to produce a mixture; ii) milling the mixture until the particle size of the active ingredient in the mixture is reduced to less than about 100 micrometers; and iii) adding more of the active ingredient and, optionally, more of the surfactant to the mixture and repeating steps i) and ii).

The milling in step ii) and step iii) may be performed with any one of the milling techniques described above (i.e., fluid energy milling, ball milling, wet milling, media milling, high pressure homogenization, shearing with a colloid mill, and/or cryogenic milling). In one aspect, the milling in step ii) and step iii) is performed by shearing with a colloid mill and/or media milling.

In certain embodiments, step iii) is performed and, optionally, repeated to achieve successively smaller particle sizes with the active ingredient in the mixture. For example, in step ii) the particle size of the active ingredient in the mixture is reduced to less than about 100 micrometers, and in the first round of step iii) the particle size of the active ingredient in the mixture is reduced to less than about 90 micrometers or less than about 80 micrometers. In subsequent rounds of step iii) the particle size of the active ingredient in the mixture is then reduced to less than about 70 micrometers or less than about 60 micrometers.

In other embodiments, the milling occurs in a mill with a controlled temperature set between about 1° C. and about 60° C., between about PC and about 55° C., between about PC and about 50° C., between about PC and about 45° C., between about PC and about 40° C., between about PC and about 35° C., between about PC and about 30° C., between about PC and about 25° C., or between about PC and about 20° C. In yet other embodiments, the milling occurs in a mill with a controlled temperature set between about 5° C. and about 60° C., between about 5° C. and about 55° C., between about 5° C. and about 50° C., between about 5° C. and about 45° C., between about 5° C. and about 40° C., between about 5° C. and about 35° C., between about 5° C. and about 30° C., between about 5° C. and about 25° C., or between about 5° C. and about 20° C.

In certain aspects, the method of increasing the concentration of an active ingredient in an agrochemical formulation while maintaining the flowability of the agrochemical formulation comprises combining a portion of the active ingredient with a surfactant to produce a mixture.

In some aspects, the active ingredient has a density of between about 0.5 and about 2.5 g/mL, between about 0.5 and about 2.0 g/mL, between about 0.5 and about 1.5 g/mL, between about 0.75 and about 2.5 g/mL, between about 0.75 and about 2.0 g/mL, between about 0.75 and about 1.5 g/mL, between about 1.0 and about 2.5 g/mL, between about 1.0 and about 2.0 g/mL, or between about 1.0 and about 1.5 g/mL. In one aspect, the active ingredient has a density of between about 1.0 and about 2.0 g/mL.

In other aspects, the active ingredient has a melting point above about 50° C., above about 75° C., above about 100° C., above about 125° C., above about 150° C., or above about 175° C. In one aspect, the active ingredient has a melting point above about 50° C. In another aspect, the active ingredient has a melting point above about 100° C.

In yet other aspects, the active ingredient has a melting point between about 50° C. and about 200° C., between about 50° C. and about 175° C., between about 50° C. and about 150° C., between about 75° C. and about 200° C., between about 75° C. and about 175° C., between about 75° C. and about 150° C., between about 100° C. and about 200° C., or between about 100° C. and about 175° C. In one aspect, the active ingredient has a melting point between about 50° C. and about 200° C. In another aspect, the active ingredient has a melting point between about 100° C. and about 200° C.

In certain embodiments, the active ingredient has a solubility in water of less than about 2000 mg/L, less than about 1750 mg/L, less than about 1500 mg/L, less than about 1250 mg/L, less than about 1000 mg/L, less than about 750 mg/L, less than about 500 mg/L, less than about 250 mg/L, or less than about 100 mg/L. In one embodiment, the active ingredient has a solubility in water of less than about 1000 mg/L. In another embodiment, the active ingredient has a solubility in water of less than about 100 mg/L.

In other embodiments, the active ingredient has a solubility in water of between about 0.01 mg/L and about 2000 mg/L, between about 0.01 mg/L and about 1750 mg/L, between about 0.01 mg/L and about 1500 mg/L, between about 0.01 mg/L and about 1250 mg/L, between about 0.01 mg/L and about 1000 mg/L, between about 0.01 mg/L and about 750 mg/L, between about 0.01 mg/L and about 500 mg/L, between about 0.01 mg/L and about 250 mg/L, or between about 0.01 mg/L and about 100 mg/L. In one embodiment, the active ingredient has a solubility in water of between about 0.01 mg/L and about 1000 mg/L. In another embodiment, the active ingredient has a solubility in water of between about 0.01 mg/L and about 100 mg/L.

In certain embodiments, the disclosed methods increase the concentration of the active ingredient in the agrochemical formulation to above 400 g/L, above 450 g/L, above 500 g/L, above 550 g/L, above 600 g/L, above 650 g/L, above 700 g/L, above 750 g/L, above 800 g/L, or above 850 g/L. In one aspect, the disclosed methods increase the concentration of the active ingredient in the agrochemical formulation to above 500 g/L.

In another aspect, the disclosed methods increase the concentration of the active ingredient in the agrochemical formulation to above 600 g/L.

In other embodiments, the disclosed methods increase the concentration of the active ingredient in the agrochemical formulation to between about 400 g/L and 900 g/L, between about 550 g/L and 850 g/L, or between about 600 g/L and 750 g/L.

In other embodiments, the viscosity of the agrochemical formulation is maintained below 2000 centipoise, below 1900 centipoise, below 1800 centipoise, below 1700 centipoise, below 1600 centipoise, below 1500 centipoise, below 1400 centipoise, below 1300 centipoise, below 1200 centipoise, below 1100 centipoise, below 1000 centipoise, below 900 centipoise, below 800 centipoise, below 700 centipoise, below 600 centipoise, below 500 centipoise, or below 400 centipoise. In one aspect, the viscosity of the agrochemical formulation is maintained below 2000 centipoise. In another aspect, the viscosity of the agrochemical formulation is maintained below 1000 centipoise.

In certain aspects, the viscosity of the agrochemical formulation is maintained between about 400 centipoise and about 1500 centipoise, between about 400 centipoise and about 1400 centipoise, between about 400 centipoise and about 1300 centipoise, between about 400 centipoise and about 1200 centipoise, between about 400 centipoise and about 1100 centipoise, between about 400 centipoise and about 1000 centipoise, between about 400 centipoise and about 900 centipoise, between about 400 centipoise and about 800 centipoise, between about 400 centipoise and about 700 centipoise, or between about 400 centipoise and about 600 centipoise.

In some embodiments, the surfactant is a nonionic surfactant, a cationic surfactant, an anionic surfactant, or an amphoteric surfactant.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of polymeric surfactants also include homo- or copolymers of vinylpyrrolidone, vinylalcohols, or vinylacetate. Suitable block polymers are block polymers of the A-B or A-B-A type comprising blocks of polyethylene oxide and polypropylene oxide, or of the A-B-C type comprising alkanol, polyethylene oxide and polypropylene oxide. Examples of sugar-based surfactants are sorbitans, ethoxylated sorbitans, sucrose and glucose esters or alkylpolyglucosides.

In one aspect, the polymeric surfactant is a poloxamer. As used herein, a “poloxamer” is nonionic triblock copolymer composed of a central hydrophobic chain of polyoxypropylene (poly(propylene oxide)) flanked by two hydrophilic chains of polyoxyethylene (poly(ethylene oxide)). The poloxamer may be any one of Poloxamer 101, Poloxamer 105, Poloxamer 108, Poloxamer 122, Poloxamer 123, Poloxamer 124, Poloxamer 181, Poloxamer 182, Poloxamer 183, Poloxamer 184, Poloxamer 185, Poloxamer 188, Poloxamer 212, Poloxamer 215, Poloxamer 217, Poloxamer 231, Poloxamer 234, Poloxamer 235, Poloxamer 237, Poloxamer 238, Poloxamer 282, Poloxamer 284, Poloxamer 288, Poloxamer 331, Poloxamer 333, Poloxamer 334, Poloxamer 335, Poloxamer 338, Poloxamer 401, Poloxamer 402, Poloxamer 403, Poloxamer 407, Poloxamer 105 Benzoate, and Poloxamer 182 Dibenzoate.

In another aspect, the polymeric surfactant is an acrylic copolymer solution. In one aspect, the acrylic copolymer solution is a polymethyl methacrylate-polyethylene glycol graft copolymer.

Suitable cationic surfactants are quaternary surfactants, for example quaternary ammonium compounds with one or two hydrophobic groups, or salts of long-chain primary amines.

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecyl-benzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

In one aspect, the sulfonate is a sulfonate of condensed naphthalenes or a salt thereof. In another aspect, the sulfonate is naphthalene sulfonate condensate (NSC) or a salt thereof.

Suitable amphoteric surfactants are alkylbetains and imidazolines. Suitable polyelectrolytes are polyacids or polybases. Examples of polyacids are alkali salts of polyacrylic acid or polyacid comb polymers. Examples of polybases are polyvinylamines or polyethyleneamines.

In some aspects, the active ingredient in the agrochemical formulation is a fungicide. In certain aspects, the fungicide is a triazole fungicide. In one aspect, the triazole fungicide is selected from the group consisting of azaconazole, bitertanol, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, propiconazole, prothioconazole, quinconazole, simeconazole, tebuconazole, tetraconazole, triadimefon, triadimenol, triticonazole, uniconazole, uniconazole-P, voriconazole, and 1-(4-chlorophenyl)-2-(1H-1,2,4-triazol-1-yl)cycloheptanol.

In another aspect, the fungicide is a strobilurin fungicide. In one aspect, the triazole fungicide is selected from the group consisting of trifloxystrobin, dimoxystrobin, fluoxastrobin, pyraclostrobin, enestroburin, picoxystrobin, azoxystrobin and mandestrobin.

The fungicide may be selected from any one of the following:

1) Inhibitors of the ergosterol biosynthesis, for example (1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazol, (1.016) prochloraz, (1.017) propiconazole, (1.018) prothioconazole, (1.019) Pyrisoxazole, (1.020) spiroxamine, (1.021) tebuconazole, (1.022) tetraconazole, (1.023) triadimenol, (1.024) tridemorph, (1.025) triticonazole, (1.026) (1R,2S,5S)-5-(4-chlorobenzyl)-2-(chloromethyl)-2-methyl-1-(1H-1,2,4-triazol-1-ylmethyl)-cyclo-pentanol, (1.027) (1S,2R,5R)-5-(4-chlorobenzyl)-2-(chloromethyl)-2-methyl-1-(1H-1,2,4-triazol-1-ylmethyl)cyclopentanol, (1.028) (2R)-2-(1-chlorocyclopropyl)-4-[(1R)-2,2-dichlorocyclopropyl]-1-(1H-1,2,4-triazol-1-yl)butan-2-ol, (1.029) (2R)-2-(1-chlorocyclopropyl)-4-[1(1S)-2,2-dichlorocyclopropyl]-1-(1H-1,2,4-triazol-1-yl)butan-2-ol, (1.030) (2R)-2-[4-(4-chlorophenoxy)-2-(trifluoromethyl)phenyl]-1-(1H-1,2,4-triazol-1-yl)-propan-2-ol, (1.031) (2S)-2-(1-chlorocyclopropyl)-4-[(1R)-2,2-dichlorocyclopropyl]-1-(1H-1,2,4-triazol-1-yl)butan-2-ol, (1.032) (2S)-2-(1-chlorocyclopropyl)-4-[(1S)-2,2-dichloro-cyclo-propyl]-1-(1H-1,2,4-triazol-1-yl)butan-2-ol, (1.033) (2S)-2-[4-(4-chlorophenoxy)-2-(trifluoromethyl)phenyl]-1-(1H-1,2,4-triazol-1-yl)propan-2-ol, (1.034) (R)-[3-(4-chloro-2-fluorophenyl)-5-(2,4-difluorophenyl)-1,2-oxazol-4-yl](pyridin-3-yl)methanol, (1.035) (S)-[3-(4-chloro-2-fluorophenyl)-5-(2,4-difluorophenyl)-1,2-oxazol-4-yl](pyridin-3-yl)methanol, (1.036) [3-(4-chloro-2-fluorophenyl)-5-(2,4-difluorophenyl)-1,2-oxazol-4-yl](pyridin-3-yl)methanol, (1.037) 1-({(2R,4S)-2-[2-chloro-4-(4-chlorophenoxy)phenyl]-4-methyl-1,3-dioxolan-2-yl}methyl)-1H-1,2,4-triazole, (1.038) 1-({(2S,4S)-2-[2-chloro-4-(4-chlorophenoxy)phenyl]-4-methyl-1,3-dioxolan-2-yl}methyl)-1H-1,2,4-triazole, (1.039) 1-{[3-(2-chlorophenyl)-2-(2,4-difluorophenyl)oxiran-2-yl]methyl}-1H-1,2,4-triazol-5-yl thiocyanate, (1.040) 1-{[rel(2R,3R)-3-(2-chlorophenyl)-2-(2,4-difluoro-phenyl)oxiran-2-yl]methyl}-1H-1,2,4-triazol-5-yl thiocyanate, (1.041) 1-{[rel(2R,3S)-3-(2-chlorophenyl)-2-(2,4-difluorophenyl)oxiran-2-yl]methyl}-1H-1,2,4-triazol-5-yl thiocyanate, (1.042) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.043) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.044) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.045) 2-[(2R,4S,5S)-1-(2,4-dichlorophenyl)-5-hydroxy-2,6,6-trimethylheptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.048) 2-[(2S,4S,5R)-1-(2,4-dichlorophenyl)-5-hydroxy-2,6,6-trimethyl-heptan-4-yl]-2,4-dihydro-3H-1,2,4-triazole-3-thione, (1.049) 2-[(2S,4S,5S)-1-(2,4-dichlorophenyl)-5-hydroxy-2,6,6-trimethylheptan-4-yl]-2,4-dihydro-3H-1,2,4-triazole-3-thione, (1.050) 2-[1-(2,4-dichlorophenyl)-5-hydroxy-2,6,6-trimethylheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl)propan-2-ol, (1.052) 2-[2-chloro-4-(4-chlorophenoxy)phenyl]-1-(1H-1,2,4-triazol-1-yl)butan-2-ol, (1.053) 2-[4-(4-chlorophenoxy)-2-(trifluoromethyl)phenyl]-1-(1H-1,2,4-triazol-1-yl)butan-2-ol, (1.054) 2-[4-(4-chlorophenoxy)-2-(trifluoromethyl)phenyl]-1-(1H-1,2,4-triazol-1-yl)pentan-2-ol, (1.055) Mefentrifluconazole, (1.056) 2-{[3-(2-chlorophenyl)-2-(2,4-difluorophenyl)oxiran-2-yl]methyl}-2,4-dihydro-3H-1,2,4-triazole-3-thione, (1.057) 2-{[rel(2R,3R)-3-(2-chlorophenyl)-2-(2,4-difluorophenyl)oxiran-2-yl]methyl}-2,4-dihydro-3H-1,2,4-triazole-3-thione, (1.058) 2-{[rel(2R,3S)-3-(2-chlorophenyl)-2-(2,4-difluoro-phenyl)-oxiran-2-yl]methyl}-2,4-dihydro-3H-1,2,4-triazole-3-thione, (1.059) 5-(4-chlorobenzyl)-2-(chloro-methyl)-2-methyl-1-(1H-1,2,4-triazol-1-ylmethyl)cyclopentanol, (1.060) 5-(allyl-sulfanyl)-1-{[3-(2-chlorophenyl)-2-(2,4-difluorophenyl)oxiran-2-yl]methyl}-1H-1,2,4-triazole, (1.061) 5-(allylsulfanyl)-1-{[rel(2R,3R)-3-(2-chlorophenyl)-2-(2,4-difluorophenyl)oxiran-2-yl]methyl}-1H-1,2,4-triazole, (1.062) 5-(allylsulfanyl)-1-{[rel(2R,3S)-3-(2-chlorophenyl)-2-(2,4-difluorophenyl)oxiran-2-yl]methyl}-1H-1,2,4-triazole, (1.063) N′-(2,5-dimethyl-4-{[3-(1,1,2,2-tetrafluoroethoxy)phenyl]sulfanyl}phenyl)-N-ethyl-N-methylimidoformamide, (1.064) N′-(2,5-dimethyl-4-{[3-(2,2,2-trifluoroethoxy)phenyl]sulfanyl}phenyl)-N-ethyl-N-methylimido-form-amide, (1.065) N′-(2,5-dimethyl-4-{[3-(2,2,3,3-tetrafluoropropoxy)phenyl]sulfanyl}phenyl)-N-ethyl-N-methylimidoformamide, (1.066) N′-(2,5-dimethyl-4-{[3-(pentafluoroethoxy)-phenyl]sulfanyl}phenyl)-N-ethyl-N-methylimidoformamide, (1.067) N′-(2,5-dimethyl-4-{3-[(1,1,2,2-tetrafluoroethyl)sulfanyl]phenoxy}phenyl)-N-ethyl-N-methylimidoformamide, (1.068) N′-(2,5-dimethyl-4-{3-[(2,2,2-trifluoroethyl)sulfanyl]phenoxy}phenyl)-N-ethyl-N-methylimido-form-amide, (1.069) N′-(2,5-dimethyl-4-{3-[(2,2,3,3-tetrafluoropropyl)sulfanyl]phenoxy}phenyl)-N-ethyl-N-methylimidoformamide, (1.070) N′-(2,5-dimethyl-4-{3-[(pentafluoroethyl)-sulfanyl]phenoxy}phenyl)-N-ethyl-N-methylimidoformamide, (1.071) N′-(2,5-dimethyl-4-phenoxy-phenyl)-N-ethyl-N-methylimidoformamide, (1.072) N′-(4-{[3-(difluoromethoxy)-phenyl]-sulfanyl}-2,5-dimethylphenyl)-N-ethyl-N-methylimidoformamide, (1.073) N′-(4-{3-[(difluoromethyl)sulfanyl]phenoxy}-2,5-dimethylphenyl)-N-ethyl-N-methylimidoformamide, (1.074) N′-[5-bromo-6-(2,3-dihydro-1H-inden-2-yloxy)-2-methylpyridin-3-yl]-N-ethyl-N-methylimido-form-amide, (1.075) N′-{4-[(4,5-dichloro-1,3-thiazol-2-yl)oxy]-2,5-dimethylphenyl}-N-ethyl-N-methylimidoformamide, (1.076) N′-{5-bromo-6-[(1R)-1-(3,5-difluorophenyl)ethoxy]-2-methylpyridin-3-yl}-N-ethyl-N-methylimidoformamide, (1.077) N′-{5-bromo-6-[(1S)-1-(3,5-difluorophenyl)ethoxy]-2-methylpyridin-3-yl}-N-ethyl-N-methylimidoformamide, (1.078) N′-{5-bromo-6-[(cis-4-isopropylcyclohexyl)oxy]-2-methylpyridin-3-yl}-N-ethyl-N-methylimidoformamide, (1.079) N′-{5-bromo-6-[(trans-4-isopropylcyclohexyl)oxy]-2-methylpyridin-3-yl}-N-ethyl-N-methylimidoformamide, (1.080) N′-{5-bromo-6-[1-(3,5-difluorophenyl)ethoxy]-2-methylpyridin-3-yl}-N-ethyl-N-methylimidoformamide, (1.081) Ipfentrifluconazole.

2) Inhibitors of the respiratory chain at complex I or II, for example (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr, (2.009) Isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) Pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamide, (2.024) 1,3-dimethyl-N-[(3S)-1,1,3-trimethyl-2,3-dihydro-1H-inden-4-yl]-1H-pyrazole-4-carboxamide, (2.025) 1-methyl-3-(trifluoromethyl)-N-[2′-(trifluoromethyl)biphenyl-2-yl]-1H-pyrazole-4-carboxamide, (2.026) 2-fluoro-6-(trifluoromethyl)-N-(1,1,3-trimethyl-2,3-dihydro-1H-inden-4-yl)benzamide, (2.027) 3-(difluoromethyl)-1-methyl-N-(1,1,3-trimethyl-2,3-dihydro-1H-inden-4-yl)-1H-pyrazole-4-carboxamide, (2.028) 3-(difluoromethyl)-1-methyl-N-[(3R)-1,1,3-trimethyl-2,3-dihydro-1H-inden-4-yl]-1H-pyrazole-4-carboxamide, (2.029) 3-(difluoromethyl)-1-methyl-N-[(3S)-1,1,3-trimethyl-2,3-dihydro-1H-inden-4-yl]-1H-pyrazole-4-carboxamide, (2.030) Fluindapyr, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide, (2.033) 5,8-difluoro-N-[2-(2-fluoro-4-{[4-(trifluoromethyl)pyridin-2-yl]oxy}-phenyl)ethyl]quinazolin-4-amine, (2.034)N-(2-cyclopentyl-5-fluorobenzyl)-N-cyclopropyl-3-(difluoromethyl)-5-fluoro-1-methyl-1H-pyrazole-4-carboxamide, (2.035)N-(2-tert-butyl-5-methylbenzyl)-N-cyclopropyl-3-(difluoromethyl)-5-fluoro-1-methyl-1H-pyrazole-4-carboxamide, (2.036)N-(2-tert-butylbenzyl)-N-cyclopropyl-3-(difluoromethyl)-5-fluoro-1-methyl-1H-pyrazole-4-carboxamide, (2.037)N-(5-chloro-2-ethylbenzyl)-N-cyclopropyl-3-(difluoromethyl)-5-fluoro-1-methyl-1H-pyrazole-4-carboxamide, (2.038) isoflucypram, (2.039)N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.040)N-[(1S,4R)-9-(dichloromethylene)-1,2,3,4-tetrahydro-1,4-methanonaphthalen-5-yl]-3-(difluoro-methyl)-1-methyl-1H-pyrazole-4-carboxamide, (2.041)N-[1-(2,4-dichlorophenyl)-1-methoxypropan-2-yl]-3-(difluoromethyl)-1-methyl-1H-pyrazole-4-carboxamide, (2.042)N-[2-chloro-6-(trifluoromethyl)benzyl]-N-cyclopropyl-3-(difluoromethyl)-5-fluoro-1-methyl-1H-pyrazole-4-carboxamide, (2.043)N-[3-chloro-2-fluoro-6-(trifluoromethyl)benzyl]-N-cyclo-propyl-3-(difluoromethyl)-5-fluoro-1-methyl-1H-pyrazole-4-carboxamide, (2.044)N-[5-chloro-2-(trifluoromethyl)benzyl]-N-cyclopropyl-3-(difluoromethyl)-5-fluoro-1-methyl-1H-pyrazole-4-carboxamide, (2.045)N-cyclopropyl-3-(difluoromethyl)-5-fluoro-1-methyl-N-[5-methyl-2-(trifluoromethyl)benzyl]-1H-pyrazole-4-carboxamide, (2.046)N-cyclopropyl-3-(difluoromethyl)-5-fluoro-N-(2-fluoro-6-isopropylbenzyl)-1-methyl-1H-pyrazole-4-carboxamide, (2.047)N-cyclopropyl-3-(difluoromethyl)-5-fluoro-N-(2-isopropyl-5-methylbenzyl)-1-methyl-1H-pyrazole-4-carboxamide, (2.048)N-cyclopropyl-3-(difluoromethyl)-5-fluoro-N-(2-isopropylbenzyl)-1-methyl-1H-pyrazole-4-carbothioamide, (2.049)N-cyclopropyl-3-(difluoromethyl)-5-fluoro-N-(2-isopropylbenzyl)-1-methyl-1H-pyrazole-4-carboxamide, (2.050)N-cyclopropyl-3-(difluoromethyl)-5-fluoro-N-(5-fluoro-2-isopropylbenzyl)-1-methyl-1H-pyrazole-4-carboxamide, (2.051) N-cyclopropyl-3-(difluoromethyl)-N-(2-ethyl-4,5-dimethylbenzyl)-5-fluoro-1-methyl-1H-pyrazole-4-carboxamide, (2.052) N-cyclopropyl-3-(difluoromethyl)-N-(2-ethyl-5-fluorobenzyl)-5-fluoro-1-methyl-1H-pyrazole-4-carboxamide, (2.053) N-cyclopropyl-3-(difluoromethyl)-N-(2-ethyl-5-methylbenzyl)-5-fluoro-1-methyl-1H-pyrazole-4-carboxamide, (2.054) N-cyclopropyl-N-(2-cyclopropyl-5-fluorobenzyl)-3-(difluoromethyl)-5-fluoro-1-methyl-1H-pyrazole-4-carboxamide, (2.055) N-cyclopropyl-N-(2-cyclopropyl-5-methylbenzyl)-3-(difluoromethyl)-5-fluoro-1-methyl-1H-pyrazole-4-carboxamide, (2.056) N-cyclopropyl-N-(2-cyclopropylbenzyl)-3-(difluoromethyl)-5-fluoro-1-methyl-1H-pyrazole-4-carboxamide, (2.057) pyrapropoyne.

3) Inhibitors of the respiratory chain at complex III, for example (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadone, (3.010) fenamidone, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin, (3.021) (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate, (3.026) mandestrobin, (3.027) N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, (3.029) methyl {5-[3-(2,4-dimethylphenyl)-1H-pyrazol-1-yl]-2-methylbenzyl}carbamate, (3.030) metyltetraprole, (3.031) florylpicoxamid.

4) Inhibitors of the mitosis and cell division, for example (4.001) carbendazim, (4.002) diethofencarb, (4.003) ethaboxam, (4.004) fluopicolide, (4.005) pencycuron, (4.006) thiabendazole, (4.007) thiophanate-methyl, (4.008) zoxamide, (4.009) 3-chloro-4-(2,6-difluorophenyl)-6-methyl-5-phenylpyridazine, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl)pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine, (4.021) 4-(2-chloro-4-fluorophenyl)-N-(2-fluorophenyl)-1,3-dimethyl-1H-pyrazol-5-amine, (4.022) 4-(4-chlorophenyl)-5-(2,6-difluorophenyl)-3,6-dimethylpyridazine, (4.023) N-(2-bromo-6-fluorophenyl)-4-(2-chloro-4-fluorophenyl)-1,3-dimethyl-1H-pyrazol-5-amine, (4.024) N-(2-bromophenyl)-4-(2-chloro-4-fluorophenyl)-1,3-dimethyl-1H-pyrazol-5-amine, (4.025) N-(4-chloro-2,6-difluorophenyl)-4-(2-chloro-4-fluorophenyl)-1,3-dimethyl-1H-pyrazol-5-amine.

5) Compounds capable to have a multisite action, for example (5.001) bordeaux mixture, (5.002) captafol, (5.003) captan, (5.004) chlorothalonil, (5.005) copper hydroxide, (5.006) copper naphthenate, (5.007) copper oxide, (5.008) copper oxychloride, (5.009) copper(2+) sulfate, (5.010) dithianon, (5.011) dodine, (5.012) folpet, (5.013) mancozeb, (5.014) maneb, (5.015) metiram, (5.016) metiram zinc, (5.017) oxine-copper, (5.018) propineb, (5.019) sulfur and sulfur preparations including calcium polysulfide, (5.020) thiram, (5.021) zineb, (5.022) ziram, (5.023) 6-ethyl-5,7-dioxo-6,7-dihydro-5H-pyrrolo[3′,4′:5,6][1,4]dithiino[2,3-c][1,2]thiazole-3-carbonitrile.

6) Compounds capable to induce a host defence, for example (6.001) acibenzolar-S-methyl, (6.002) isotianil, (6.003) probenazole, (6.004) tiadinil.

7) Inhibitors of the amino acid and/or protein biosynthesis, for example (7.001) cyprodinil, (7.002) kasugamycin, (7.003) kasugamycin hydrochloride hydrate, (7.004) oxytetracycline, (7.005) pyrimethanil, (7.006) 3-(5-fluoro-3,3,4,4-tetramethyl-3,4-dihydroisoquinolin-1-yl)quinoline.

8) Inhibitors of the ATP production, for example (8.001) silthiofam.

9) Inhibitors of the cell wall synthesis, for example (9.001) benthiavalicarb, (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl)prop-2-en-1-one, (9.009) (2Z)-3-(4-tert-butylphenyl)-3-(2-chloropyridin-4-yl)-1-(morpholin-4-yl)prop-2-en-1-one.

10) Inhibitors of the lipid and membrane synthesis, for example (10.001) propamocarb, (10.002) propamocarb hydrochloride, (10.003) tolclofos-methyl.

11) Inhibitors of the melanin biosynthesis, for example (11.001) tricyclazole, (11.002) 2,2,2-trifluoroethyl {3-methyl-1-[(4-methylbenzoyl)amino]butan-2-yl}carbamate.

12) Inhibitors of the nucleic acid synthesis, for example (12.001) benalaxyl, (12.002) benalaxyl-M (kiralaxyl), (12.003) metalaxyl, (12.004) metalaxyl-M (mefenoxam).

13) Inhibitors of the signal transduction, for example (13.001) fludioxonil, (13.002) iprodione, (13.003) procymidone, (13.004) proquinazid, (13.005) quinoxyfen, (13.006) vinclozolin.

14) Compounds capable to act as an uncoupler, for example (14.001) fluazinam, (14.002) meptyldinocap.

15) Further compounds, for example (15.001) Abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) fosetyl-aluminium, (15.013) fosetyl-calcium, (15.014) fosetyl-sodium, (15.015) methyl isothiocyanate, (15.016) metrafenone, (15.017) mildiomycin, (15.018) natamycin, (15.019) nickel dimethyldithiocarbamate, (15.020) nitrothal-isopropyl, (15.021) oxamocarb, (15.022) oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl)quinazoline, (15.034) dipymetitrone, (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)-piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]-ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) Ipflufenoquin, (15.042) 2-{2-fluoro-6-[(8-fluoro-2-methylquinolin-3-yl)oxy]phenyl}propan-2-ol, (15.043) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, (15.045) 2-phenylphenol and salts, (15.046) 3-(4,4,5-trifluoro-3,3-dimethyl-3,4-dihydroisoquinolin-1-yl)quinoline, (15.047) quinofumelin, (15.048) 4-amino-5-fluoropyrimidin-2-ol (tautomeric form: 4-amino-5-fluoropyrimidin-2(1H)-one), (15.049) 4-oxo-4-[(2-phenylethyl)amino]butanoic acid, (15.050) 5-amino-1,3,4-thiadiazole-2-thiol, (15.051) 5-chloro-N′-phenyl-N′-(prop-2-yn-1-yl)thiophene-2-sulfonohydrazide, (15.052) 5-fluoro-2-[(4-fluorobenzyl)oxy]pyrimidin-4-amine, (15.053) 5-fluoro-2-[(4-methylbenzyl)-oxy]-pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-1H-tetrazol-5-yl)-(phenyl)-methylene]amino}oxy)methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}-carbamate, (15.062) 5-fluoro-4-imino-3-methyl-1-[(4-methylphenyl)sulfonyl]-3,4-dihydro-pyrimidin-2(1H)-one, (15.063) aminopyrifen.

All named mixing partners of the classes (1) to (15) as described here above can be present in the form of the free compound and/or, if their functional groups enable this, an agriculturally acceptable salt thereof.

In other aspects, the active ingredient in the agrochemical formulation is an insecticide. The insecticide may be selected from any one of the following:

(1) Acetylcholinesterase (AChE) inhibitors, such as, for example, carbamates, for example alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb; or organophosphates, for example acephate, azamethiphos, azinphos-ethyl, azinphos-methyl, cadusafos, chlorethoxyfos, chlorfenvinphos, chlormephos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion.

(2) GABA-gated chloride channel blockers, such as, for example, cyclodiene-organochlorines, for example chlordane and endosulfan or phenylpyrazoles (fiproles), for example ethiprole and fipronil.

(3) Sodium channel modulators, such as, for example, pyrethroids, e.g., acrinathrin, allethrin, d-cis-trans allethrin, d-trans allethrin, bifenthrin, bioallethrin, bioallethrin s-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin [(1R)-trans-isomer], deltamethrin, empenthrin [(EZ)-(1R)-isomer], esfenvalerate, etofenprox, fenpropathrin, fenvalerate, flucythrinate, flumethrin, tau-fluvalinate, halfenprox, imiprothrin, kadethrin, momfluorothrin, permethrin, phenothrin [(1R)-trans-isomer], prallethrin, pyrethrins (pyrethrum), resmethrin, silafluofen, tefluthrin, tetramethrin, tetramethrin [(1R)-isomer)], tralomethrin and transfluthrin or DDT or methoxychlor.

(4) Nicotinic acetylcholine receptor (nAChR) competitive modulators, such as, for example, neonicotinoids, e.g., acetamiprid, clothianidin, dinotefuran, imidacloprid, nitenpyram, thiacloprid and thiamethoxam or nicotine or sulfoxaflor or flupyradifurone.

(5) Nicotinic acetylcholine receptor (nAChR) allosteric modulators, such as, for example, spinosyns, e.g., spinetoram and spinosad.

(6) Glutamate-gated chloride channel (GluCl) allosteric modulators, such as, for example, avermectins/milbemycins, for example abamectin, emamectin benzoate, lepimectin and milbemectin.

(7) Juvenile hormone mimics, such as, for example, juvenile hormone analogues, e.g., hydroprene, kinoprene and methoprene or fenoxycarb or pyriproxyfen.

(8) Miscellaneous non-specific (multi-site) inhibitors, such as, for example, alkyl halides, e.g., methyl bromide and other alkyl halides; or chloropicrine or sulphuryl fluoride or borax or tartar emetic or methyl isocyanate generators, e.g., diazomet and metam.

(9) Modulators of Chordotonal Organs, such as, for example pymetrozine or flonicamid.

(10) Mite growth inhibitors, such as, for example clofentezine, hexythiazox and diflovidazin or etoxazole.

(11) Microbial disruptors of the insect gut membrane, such as, for example Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and B.t. plant proteins: Cry1Ab, Cry1Ac, Cry1Fa, Cry1A.105, Cry2Ab, Vip3A, mCry3A, Cry3Ab, Cry3Bb, Cry34Abl/35Abl.

(12) Inhibitors of mitochondrial ATP synthase, such as, ATP disruptors such as, for example, diafenthiuron or organotin compounds, for example azocyclotin, cyhexatin and fenbutatin oxide or propargite or tetradifon.

(13) Uncouplers of oxidative phosphorylation via disruption of the proton gradient, such as, for example, chlorfenapyr, DNOC and sulfluramid.

(14) Nicotinic acetylcholine receptor channel blockers, such as, for example, bensultap, cartap hydrochloride, thiocylam, and thiosultap-sodium.

(15) Inhibitors of chitin biosynthesis, type 0, such as, for example, bistrifluron, chlorfluazuron, diflubenzuron, flucycloxuron, flufenoxuron, hexaflumuron, lufenuron, novaluron, noviflumuron, teflubenzuron and triflumuron.

(16) Inhibitors of chitin biosynthesis, type 1, for example buprofezin.

(17) Moulting disruptor (in particular for Diptera, i.e., dipterans), such as, for example, cyromazine.

(18) Ecdysone receptor agonists, such as, for example, chromafenozide, halofenozide, methoxyfenozide and tebufenozide.

(19) Octopamine receptor agonists, such as, for example, amitraz.

(20) Mitochondrial complex III electron transport inhibitors, such as, for example, hydramethylnone or acequinocyl or fluacrypyrim.

(21) Mitochondrial complex I electron transport inhibitors, such as, for example from the group of the METI acaricides, e.g., fenazaquin, fenpyroximate, pyrimidifen, pyridaben, tebufenpyrad and tolfenpyrad or rotenone (Derris).

(22) Voltage-dependent sodium channel blockers, such as, for example indoxacarb or metaflumizone.

(23) Inhibitors of acetyl CoA carboxylase, such as, for example, tetronic and tetramic acid derivatives, e.g., spirodiclofen, spiromesifen and spirotetramat.

(24) Mitochondrial complex IV electron transport inhibitors, such as, for example, phosphines, e.g., aluminium phosphide, calcium phosphide, phosphine and zinc phosphide or cyanides, e.g., calcium cyanide, potassium cyanide and sodium cyanide.

(25) Mitochondrial complex II electron transport inhibitors, such as, for example, beta-ketonitrile derivatives, e.g., cyenopyrafen and cyflumetofen and carboxanilides, such as, for example, pyflubumide.

(28) Ryanodine receptor modulators, such as, for example, diamides, e.g., chlorantraniliprole, cyantraniliprole and flubendiamide.

Further active compounds such as, for example, Afidopyropen, Afoxolaner, Azadirachtin, Benclothiaz, Benzoximate, Bifenazate, Broflanilide, Bromopropylate, Chinomethionat, Chloroprallethrin, Cryolite, Cyclaniliprole, Cycloxaprid, Cyhalodiamide, Dicloromezotiaz, Dicofol, epsilon-Metofluthrin, epsilon-Momfluthrin, Flometoquin, Fluazaindolizine, Fluensulfone, Flufenerim, Flufenoxystrobin, Flufiprole, Fluhexafon, Fluopyram, Fluralaner, Fluxametamide, Fufenozide, Guadipyr, Heptafluthrin, Imidaclothiz, Iprodione, kappa-Bifenthrin, kappa-Tefluthrin, Lotilaner, Meperfluthrin, Paichongding, Pyridalyl, Pyrifluquinazon, Pyriminostrobin, Spirobudiclofen, Tetramethylfluthrin, Tetraniliprole, Tetrachlorantraniliprole, Tigolaner, Tioxazafen, Thiofluoximate, Triflumezopyrim and iodomethane; furthermore preparations based on Bacillus firmus (I-1582, BioNeem, VOTIVO®), and also the following compounds: 1-{2-fluoro-4-methyl-5-[(2,2,2-trifluoroethyl)sulphinyl]phenyl}-3-(trifluoromethyl)-1H-1,2,4-triazole-5-amine (known from WO 2006/043635) (CAS 885026-50-6), {1′-[(2E)-3-(4-chlorophenyl)prop-2-en-1-yl]-5-fluorospiro[indol-3,4′-piperidin]-1(2H)-yl}(2-chloropyridin-4-yl)methanone (known from WO 2003/106457) (CAS 637360-23-7), 2-chloro-N-[2-{1-[(2E)-3-(4-chlorophenyl)prop-2-en-1-yl]piperidin-4-yl}-4-(trifluoromethyl)phenyl]isonicotinamide (known from WO 2006/003494) (CAS 872999-66-1), 3-(4-chloro-2,6-dimethylphenyl)-4-hydroxy-8-methoxy-1,8-diazaspiro[4.5]dec-3-en-2-one (known from WO 2010/052161) (CAS 1225292-17-0), 3-(4-chloro-2,6-dimethylphenyl)-8-methoxy-2-oxo-1,8-diazaspiro[4.5]dec-3-en-4-yl ethyl carbonate (known from EP 2647626) (CAS 1440516-42-6), 4-(but-2-yn-1-yloxy)-6-(3,5-dimethylpiperidin-1-yl)-5-fluoropyrimidine (known from WO 2004/099160) (CAS 792914-58-0), PF1364 (known from JP 2010/018586) (CAS 1204776-60-2), N-[(2E)-1-[(6-chloropyridin-3-yl)methyl]pyridin-2(1H)-ylidene]-2,2,2-trifluoroacetamide (known from WO 2012/029672) (CAS 1363400-41-2), (3E)-3-[1-[(6-chloro-3-pyridyl)methyl]-2-pyridylidene]-1,1,1-trifluoro-propan-2-one (known from WO 2013/144213) (CAS 1461743-15-6), N-[3-(benzylcarbamoyl)-4-chlorophenyl]-1-methyl-3-(pentafluoroethyl)-4-(trifluoromethyl)-1H-pyrazole-5-carboxamide (known from WO 2010/051926) (CAS 1226889-14-0), 5-bromo-4-chloro-N-[4-chloro-2-methyl-6-(methylcarbamoyl)phenyl]-2-(3-chloro-2-pyridyl)pyrazole-3-carboxamide (known from CN 103232431) (CAS 1449220-44-3), 4-[5-(3,5-dichlorophenyl)-4,5-dihydro-5-(trifluoromethyl)-3-isoxazolyl]-2-methyl-N-(cis-1-oxido-3-thietanyl)-benzamide, 4-[5-(3,5-dichlorophenyl)-4,5-dihydro-5-(trifluoromethyl)-3-isoxazolyl]-2-methyl-N-(trans-1-oxido-3-thietanyl)-benzamide and 4-[(5S)-5-(3,5-dichlorophenyl)-4,5-dihydro-5-(trifluoromethyl)-3-isoxazolyl]-2-methyl-N-(cis-1-oxido-3-thietanyl)benzamide (known from WO 2013/050317 A1) (CAS 1332628-83-7), N-[3-chloro-1-(3-pyridinyl)-1H-pyrazol-4-yl]-N-ethyl-3-[(3,3,3-trifluoropropyl)sulfinyl]-propanamide, (+)-N-[3-chloro-1-(3-pyridinyl)-1H-pyrazol-4-yl]-N-ethyl-3-[(3,3,3-trifluoropropyl)sulfinyl]-propanamide and (−)-N-[3-chloro-1-(3-pyridinyl)-1H-pyrazol-4-yl]-N-ethyl-3-[(3,3,3-trifluoropropyl)sulfinyl]-propanamide (known from WO 2013/162715 A2, WO 2013/162716 A2, US 2014/0213448 A1) (CAS 1477923-37-7), 5-[[(2E)-3-chloro-2-propen-1-yl]amino]-1-[2,6-dichloro-4-(trifluoromethyl)phenyl]-4-[(trifluoromethyl)sulfinyl]-1H-pyrazole-3-carbonitrile (known from CN 101337937 A) (CAS 1105672-77-2), 3-bromo-N-[4-chloro-2-methyl-6-[(methylamino)thioxomethyl]phenyl]-1-(3-chloro-2-pyridinyl)-1H-pyrazole-5-carboxamide, (Liudaibenjiaxuanan, known from CN 103109816 A) (CAS 1232543-85-9); N-[4-chloro-2-[[(1,1-dimethylethyl)amino]carbonyl]-6-methylphenyl]-1-(3-chloro-2-pyridinyl)-3-(fluoromethoxy)-1H-Pyrazole-5-carboxamide (known from WO 2012/034403 A1) (CAS 1268277-22-0), N-[2-(5-amino-1,3,4-thiadiazol-2-yl)-4-chloro-6-methylphenyl]-3-bromo-1-(3-chloro-2-pyridinyl)-1H-pyrazole-5-carboxamide (known from WO 2011/085575 A1) (CAS 1233882-22-8), 4-[3-[2,6-dichloro-4-[(3,3-dichloro-2-propen-1-yl)oxy]phenoxy]propoxy]-2-methoxy-6-(trifluoromethyl)-pyrimidine (known from CN 101337940 A) (CAS 1108184-52-6); (2E)- and 2(Z)-2-[2-(4-cyanophenyl)-1-[3-(trifluoromethyl)phenyl]ethylidene]-N-[4-(difluoromethoxy)phenyl]-hydrazinecarboxamide (known from CN 101715774 A) (CAS 1232543-85-9); 3-(2,2-dichloroethenyl)-2,2-dimethyl-4-(1H-benzimidazol-2-yl)phenyl-cyclopropanecarboxylic acid ester (known from CN 103524422 A) (CAS 1542271-46-4); (4aS)-7-chloro-2,5-dihydro-2-[[(methoxycarbonyl)[4-[(trifluoromethyl)thio]phenyl]amino]carbonyl]-indeno[1,2-e][1,3,4]oxadiazine-4a(3H)-carboxylic acid methyl ester (known from CN 102391261 A) (CAS 1370358-69-2); 6-deoxy-3-O-ethyl-2,4-di-O-methyl-, 1-[N-[4-[1-[4-(1,1,2,2,2-pentafluoroethoxy)phenyl]-1H-1,2,4-triazol-3-yl]phenyl]carbamate]-α-L-mannopyranose (known from US 2014/0275503 A1) (CAS 1181213-14-8); 8-(2-cyclopropylmethoxy-4-trifluoromethyl-phenoxy)-3-(6-trifluoromethyl-pyridazin-3-yl)-3-aza-bicyclo[3.2.1]octane (CAS 1253850-56-4), (8-anti)-8-(2-cyclopropylmethoxy-4-trifluoromethyl-phenoxy)-3-(6-trifluoromethyl-pyridazin-3-yl)-3-aza-bicyclo[3.2.1]octane (CAS 933798-27-7), (8-syn)-8-(2-cyclopropylmethoxy-4-trifluoromethyl-phenoxy)-3-(6-trifluoromethyl-pyridazin-3-yl)-3-aza-bicyclo[3.2.1]octane (known from WO 2007040280 A1, WO 2007/040282 A1) (CAS 934001-66-8), N-[3-chloro-1-(3-pyridinyl)-1H-pyrazol-4-yl]-N-ethyl-3-[(3,3,3-trifluoropropyl)thio]-propanamide (known from WO 2015/058021 A1, WO 2015/058028 A1) (CAS 1477919-27-9) and N-[4-(aminothioxomethyl)-2-methyl-6-[(methylamino)carbonyl]phenyl]-3-bromo-1-(3-chloro-2-pyridinyl)-1H-pyrazole-5-carboxamide (known from CN 103265527 A) (CAS 1452877-50-7), 5-(1,3-dioxan-2-yl)-4-[[4-(trifluoromethyl)phenyl]methoxy]-pyrimidine (known from WO 2013/115391 A1) (CAS 1449021-97-9), 3-(4-chloro-2,6-dimethylphenyl)-4-hydroxy-8-methoxy-1-methyl-1,8-diazaspiro[4.5]dec-3-en-2-one (known from WO 2010/066780 A1, WO 2011/151146 A1) (CAS 1229023-34-0), 3-(4-chloro-2,6-dimethylphenyl)-8-methoxy-1-methyl-1,8-diazaspiro[4.5]decane-2,4-dione (known from WO 2014/187846 A1) (CAS 1638765-58-8), 3-(4-chloro-2,6-dimethylphenyl)-8-methoxy-1-methyl-2-oxo-1,8-diazaspiro[4.5]dec-3-en-4-yl-carbonic acid ethyl ester (known from WO 2010/066780 A1, WO 2011151146 A1) (CAS 1229023-00-0), N-[1-[(6-chloro-3-pyridinyl)methyl]-2(1H)-pyridinylidene]-2,2,2-trifluoro-acetamide (known from DE 3639877 A1, WO 2012/029672 A1) (CAS 1363400-41-2), [N(E)]-N-[1-[(6-chloro-3-pyridinyl)methyl]-2(1H)-pyridinylidene]-2,2,2-trifluoro-acetamide, (known from WO 2016005276 A1) (CAS 1689566-03-7), [N(Z)]-N-[1-[(6-chloro-3-pyridinyl)methyl]-2(1H)-pyridinylidene]-2,2,2-trifluoro-acetamide, (CAS 1702305-40-5), 3-endo-3-[2-propoxy-4-(trifluoromethyl)phenoxy-9-[[5-(trifluoromethyl)-2-pyridinyl]oxy]-9-azabicyclo[3.3.1]nonane (known from WO 2011/105506 A1, WO 2016/133011 A1) (CAS 1332838-17-1).

In certain embodiments, the active ingredient is a fungicide or an insecticide selected from those shown in Table 1.

TABLE 1

| | Density | Melting | Solubility in | |
|---|---|---|---|---|
| A.I. | (g/mL) | Point (° C.) | Water (mg/L) | Class |
| Azoxystrobin | 1.34^{a} | 116^{a} | 6.01^{a} | Fungicide |
| Beta-Cyfluthrin | 1.35 | 93.5 | 0.0012 | Fungicide |
| Carbendazim | 1.45 | 305 | 8 | Fungicide |
| Carbendazim | 1.39^{a} | 190^{a} | 797^{a} | Fungicide |
| Cyproconazole | 1.31^{a} | 106^{a} | 140^{a} | Fungicide |
| Epoxiconazole | 1.42^{a} | 128^{a} | 577^{a} | Fungicide |
| Fenamidone | 1.29 | 136.8 | 7.8 | Fungicide |
| Fluazinam | 1.80^{a} | 115^{a} | 0.68^{a} | Fungicide |
| Fludioxinil | 1.54 | 199.8 | 1.8 | Fungicide |
| Fluopyram | 1.53 | 117.5 | 16 | Fungicide |
| Fluoxastrobin | 1.42 | 105 | 2.29 | Fungicide |
| Fluquinconazole | 1.58 | 191 | 1.15 | Fungicide |
| Ipconazole | 1.2 | 86 | 9.344 | Fungicide |
| Iprodione | 1 | 134 | 6.8 | Fungicide |
| Isotianil | 1.56^{a} | 186^{a} | 0.5 | Fungicide |
| Metalaxyl | 1.2 | 72 | 8400 | Fungicide |
| Metalaxyl-M | 1.09^{a} | 67.4^{a} | 10168^{a} | Fungicide |
| Metominostrobin | 1.13^{a} | 88^{a} | 128^{a} | Fungicide |
| Pencycuron | 1.22 | 132 | 0.3 | Fungicide |
| Penflufen | 1.18^{a} | 111 | 10.9 | Fungicide |
| Picarbutrazox | 1.3^{b} | N.D. | N.D. | Fungicide |
| Picoxystrobin | 1.28^{a} | 89.2^{a} | 8.30^{a} | Fungicide |
| Procymidone | 1.43^{a} | 166^{a} | 4.49^{a} | Fungicide |
| Propiconazole | 1.39^{a} | 103^{a} | 109^{a} | Fungicide |
| Prothioconazole | 1.36 | 141.8 | 300 | Fungicide |
| Pyraclostrobin | 1.34^{a} | 64.5^{a} | 26.0^{a} | Fungicide |
| Tebuconazole | 1.25 | 105 | 36 | Fungicide |
| Triadimenol | 1.27 | 132.5 | 72 | Fungicide |
| Trifloxystrobin | 1.36 | 72.9 | 0.61 | Fungicide |
| Abamectin | 1.28^{a} | 227^{a} | 36.4^{a} | Insecticide |
| Chlorantraniliprole | 1.65^{a} | 230^{a} | 1.33^{a} | Insecticide |
| Clothianidin | 1.61 | 176.8 | 340 | Insecticide |
| Cyantraniliprole | 1.65^{a} | 232^{a} | 37.5^{a} | Insecticide |
| Ethiprole | 1.69 | 188^{a} | 31.7^{a} | Insecticide |
| Fipronil | 1.71 | 203 | 3.78 | Insecticide |
| Flubendiamide | 1.78^{a} | 219^{a} | 0.10^{a} | Insecticide |
| Flupyradifurone | 1.43 | 69 | 3200 | Insecticide |
| Imidacloprid | 1.54 | 144 | 610 | Insecticide |
| Methiocarb | 1.25 | 118.5 | 27 | Insecticide |
| Spinetoram | 1.18^{a} | 198^{a} | 162^{a} | Insecticide |
| Spinosad | 1.20^{a} | 198^{a} | 295^{a} | Insecticide |
| Sulfoxaflor | 1.34^{a} | 141^{a} | 3189^{a} | Insecticide |
| Tefluthrin | 1.48 | 44.6 | 0.016 | Insecticide |
| Thiacloprid | 1.46 | 134^{a} | 184 | Insecticide |
| Thiamethoxam | 1.76^{a} | 158^{a} | 1278^{a} | Insecticide |
| Thiodicarb | 1.47 | 172.6 | 22.2 | Insecticide |

N.D.: Not Determined;
^{a}Values from the Chemistry Dashboard of the US Environmental Protection Agency;
^{b}Values predicted with the ACD/Labs Percepta Plaform - PhysChem Module.

In some embodiments, the active ingredient has a melting point above about 35° C., above about 40° C., above about 45° C., above about 50° C., above about 55° C., above about 60° C., above about 65° C., above about 70° C., above about 75° C., above about 80° C., above about 85° C., above about 90° C., above about 95° C., or above about 100° C. In other embodiments, the active ingredient has a melting point above about 100° C., above about 125° C., or above about 150° C.

In yet other embodiments, the milling is continued until the particle size of the active ingredient is between about 1 micrometer and about 20 micrometers. The particle size may be within any range within these parameters including, but not limited to, between about 1 micrometer and about 20 micrometers, between about 1 micrometer and about 15 micrometers, between about 1 micrometer and about 10 micrometers, between about 1 micrometer and about 5 micrometers, between about 3 micrometer and about 20 micrometers, between about 3 micrometers and about 15 micrometers, between about 3 micrometers and about 10 micrometers, between about 3 micrometers and about 8 micrometers, or between about 3 micrometers and about 5 micrometers. In one aspect, the milling is continued until the particle size of the active ingredient is between about 3 micrometers and about 8 micrometers. In another aspect, the milling is continued until the particle size of the active ingredient is between about 4 micrometers and about 6 micrometers. In another aspect, the milling is continued until the particle size of the active ingredient is between about 5.0 micrometers and about 5.5 micrometers.

The particles size may be measured by any method known in the art such as laser diffraction, FBRM (focused beam reflectance measurement), UAS (ultrasonic attenuation spectroscopy), PDA (phase Doppler method), SFT (spatial filtering technique), or SDV (shadow Doppler velocimetry).

The aqueous formulation may optionally include auxiliary agents commonly used in agricultural treatment formulations and known to those skilled in the art. Examples include antioxidants such as ascorbic acid, penetrants, biocides, preservatives, deodorizers, fragrances, antifreezes and evaporation inhibitors such as glycerol and ethylene or propylene glycol, sorbitol, mineral oil, process oils, sodium lactate, fillers, carriers, colorants including pigments and/or dyes, pH modifiers (buffers, acids, and bases), salts such as calcium, magnesium, ammonium, potassium, sodium, and/or iron chlorides, fertilizers such as ammonium sulfate and ammonium nitrate, urea, and surfactants such as dispersing agents, emulsifiers, wetting agents, defoamers and suspension agents. The aqueous formulation may also contain other active ingredients such as additional fungicides, insecticides, pesticides, and/or fertilizers known in the art, provided they are compatible with prothioconazole.

Suitable defoamers include all customary defoamers including silicone-based and those based upon perfluoroalkyl phosphinic and phosphonic acids, in particular silicone-based defoamers, such as silicone oils, for example.

Defoamers most commonly used are those from the group of linear polydimethylsiloxanes having an average dynamic viscosity, measured at 25° C., in the range from 1000 to 8000 mPas (mPas=millipascal-second), usually 1200 to 6000 mPas, and containing silica. Silica includes polysilicic acids, meta-silicic acid, ortho-silicic acid, silica gel, silicic acid gels, kieselguhr, precipitated SiO₂, and the like.

Defoamers from the group of linear polydimethylsiloxanes contain as their chemical backbone a compound of the formula HO—[Si(CH₃)₂—O—]ₙ—H, in which the end groups are modified, by etherification for example, or are attached to the groups —Si(CH₃)₃. Non-limiting examples of defoamers of this kind are RHODORSIL® Antifoam 416 (Rhodia) and RHODORSIL® Antifoam 481 (Rhodia). Other suitable defoamers are RHODORSIL® 1824, ANTIMUSSOL 4459-2 (Clariant), Defoamer V 4459 (Clariant), SE Visk and AS EM SE 39 (Wacker). The silicone oils can also be used in the form of emulsions.

The present invention also relates to propagation material of plants treated with agrochemical formulations according to the invention. Here, the term “propagation material” encompasses those components of the plant which are suitable for producing progeny in a vegetative or sexual manner. Suitable for vegetative propagation are, for example, cuttings, callus cultures, rhizomes or tubers. Other propagation material encompasses, for example, fruits, seeds, seedlings, protoplasts, cell cultures, etc. Preferred propagation materials are tubers, fruits or seeds.

In some embodiments, the agrochemical formulation is a seed treatment formulation. These formulations may be used to protect seeds from unwanted microorganisms, such as phytopathogenic microorganisms, for instance phytopathogenic fungi or phytopathogenic oomycetes. The term seed(s) as used herein include dormant seeds, primed seeds, pregerminated seeds and seeds with emerged roots and leaves.

Thus, the present invention also relates to a method for protecting seeds from unwanted microorganisms which comprises the step of treating the seeds with the formulations of the present invention.

The treatment of seeds with the formulations of the present invention protects the seeds from phytopathogenic microorganisms, but also protects the germinating seeds, the emerging seedlings and the plants after emergence from the treated seeds. Therefore, the present invention also relates to a method for protecting seeds, germinating seeds and emerging seedlings.

The seeds treatment may be performed prior to sowing, at the time of sowing or shortly thereafter.

When the seeds treatment is performed prior to sowing (e.g., so-called on-seed applications), the seeds treatment may be performed as follows: the seeds may be placed into a mixer with a desired amount of the formulations of the present invention, the seeds and the formulations of the present invention are mixed until an homogeneous distribution on seeds is achieved. If appropriate, the seeds may then be dried.

The invention also relates to seeds coated with the formulations of the present invention.

Preferably, the seeds are treated in a state in which it is sufficiently stable for no damage to occur in the course of treatment. In general, seeds can be treated at any time between harvest and shortly after sowing. It is customary to use seeds which have been separated from the plant and freed from cobs, shells, stalks, coats, hairs or the flesh of the fruits. For example, it is possible to use seeds which have been harvested, cleaned and dried down to a moisture content of less than 15% by weight. Alternatively, it is also possible to use seeds which, after drying, for example, have been treated with water and then dried again, or seeds just after priming, or seeds stored in primed conditions or pre-germinated seeds, or seeds sown on nursery trays, tapes or paper.

The amount of the formulations of the present invention applied to the seeds is typically such that the germination of the seed is not impaired, or that the resulting plant is not damaged. The intrinsic phenotypes of transgenic plants should also be taken into consideration when determining the amount of the formulations of the present invention to be applied to the seed in order to achieve optimum seed and germinating plant protection with a minimum amount of active ingredients being employed.

The formulations of the present invention can be applied as such, directly to the seeds, i.e. without the use of any other components and without having been diluted. Also, the composition of the invention can be applied to the seeds.

The formulations of the present invention are suitable for protecting seeds of any plant variety. Preferred seeds are that of cereals (such as wheat, barley, rye, millet, triticale, and oats), oilseed rape, maize, cotton, soybean, rice, potatoes, sunflower, beans, coffee, peas, beet (e.g., sugar beet and fodder beet), peanut, vegetables (such as tomato, cucumber, onions and lettuce), lawns and ornamental plants. More preferred are seeds of wheat, soybean, oilseed rape, maize and rice.

The formulations of the present invention may be used for treating transgenic seeds, in particular seeds of plants capable of expressing a polypeptide or protein which acts against pests, herbicidal damage or abiotic stress, thereby increasing the protective effect. Seeds of plants capable of expressing a polypeptide or protein which acts against pests, herbicidal damage or abiotic stress may contain at least one heterologous gene which allows the expression of said polypeptide or protein. These heterologous genes in transgenic seeds may originate, for example, from microorganisms of the species Bacillus, Rhizobium, Pseudomonas, Serratia, Trichoderma, Clavibacter, Glomus or Gliocladium. These heterologous genes preferably originate from Bacillus sp., in which case the gene product is effective against the European corn borer and/or the Western corn rootworm. Particularly preferably, the heterologous genes originate from Bacillus thuringiensis.

The present invention further provides formulations, and application forms prepared from them, as crop protection agents and/or pesticidal agents, such as drench, drip and spray liquors, comprising at least one of the active compounds of the invention. The application forms may comprise further crop protection agents and/or pesticidal agents, and/or activity-enhancing adjuvants such as penetrants, examples being vegetable oils such as, for example, rapeseed oil, sunflower oil, mineral oils such as, for example, liquid paraffins, alkyl esters of vegetable fatty acids, such as rapeseed oil or soybean oil methyl esters, or alkanol alkoxylates, and/or spreaders such as, for example, alkylsiloxanes and/or salts, examples being organic or inorganic ammonium or phosphonium salts, examples being ammonium sulphate or diammonium hydrogen phosphate, and/or retention promoters such as dioctyl sulphosuccinate or hydroxypropylguar polymers and/or humectants such as glycerol and/or fertilizers such as ammonium, potassium or phosphorous fertilizers, for example.

Examples of typical formulations include water-soluble liquids (SL), emulsifiable concentrates (EC), emulsions in water (EW), suspension concentrates (SC, SE, FS, OD), water-dispersible granules (WG), granules (GR) and capsule concentrates (CS); these and other possible types of formulation are described, for example, by Crop Life International and in Pesticide Specifications, Manual on Development and Use of FAO and WHO Specifications for Pesticides, FAO Plant Production and Protection Papers—173, prepared by the FAO/WHO Joint Meeting on Pesticide Specifications, 2004, ISBN: 9251048576. The formulations may comprise active agrochemical compounds other than one or more active compounds of the invention.

The formulations or application forms in question preferably comprise auxiliaries, such as extenders, solvents, spontaneity promoters, carriers, emulsifiers, dispersants, frost protectants, biocides, thickeners and/or other auxiliaries, such as adjuvants, for example. An adjuvant in this context is a component which enhances the biological effect of the formulation, without the component itself having a biological effect. Examples of adjuvants are agents which promote the retention, spreading, attachment to the leaf surface, or penetration.

These formulations are produced, for example by mixing the active compounds with auxiliaries such as, for example, extenders, solvents and/or solid carriers and/or further auxiliaries, such as, for example, surfactants. The formulations are prepared either in suitable plants or else before or during the application.

Suitable for use as auxiliaries are substances which are suitable for imparting to the formulation of the active compound or the application forms prepared from these formulations (such as, e.g., usable crop protection agents, such as spray liquors or seed dressings) particular properties such as certain physical, technical and/or biological properties.

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide).

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethylformamide and dimethyl sulphoxide, and also water.

It is possible to use all suitable solvents. Suitable solvents are, for example, aromatic hydrocarbons, such as xylene, toluene or alkylnaphthalenes, for example, chlorinated aromatic or aliphatic hydrocarbons, such as chlorobenzene, chloroethylene or methylene chloride, for example, aliphatic hydrocarbons, such as cyclohexane, for example, paraffins, petroleum fractions, mineral and vegetable oils, alcohols, such as methanol, ethanol, isopropanol, butanol or glycol, for example, and also their ethers and esters, ketones such as acetone, methyl ethyl ketone, methyl isobutyl ketone or cyclohexanone, for example, strongly polar solvents, such as dimethyl sulphoxide, and water.

All suitable carriers may be used. Suitable carriers are in particular: for example, ammonium salts and ground natural minerals such as kaolins, clays, talc, chalk, quartz, attapulgite, montmorillonite or diatomaceous earth, and ground synthetic minerals, such as finely divided silica, alumina and natural or synthetic silicates, resins, waxes and/or solid fertilizers. Mixtures of such carriers may likewise be used. Carriers suitable for granules include the following: for example, crushed and fractionated natural minerals such as calcite, marble, pumice, sepiolite, dolomite, and also synthetic granules of inorganic and organic meals, and also granules of organic material such as sawdust, paper, coconut shells, maize cobs and tobacco stalks.

Liquefied gaseous extenders or solvents may also be used. Particularly suitable are those extenders or carriers which at standard temperature and under standard pressure are gaseous, examples being aerosol propellants, such as halogenated hydrocarbons, and also butane, propane, nitrogen and carbon dioxide.

Examples of emulsifiers and/or foam-formers, dispersants or wetting agents having ionic or nonionic properties, or mixtures of these surface-active substances, are salts of polyacrylic acid, salts of lignosulphonic acid, salts of phenolsulphonic acid or naphthalenesulphonic acid, polycondensates of ethylene oxide with fatty alcohols or with fatty acids or with fatty amines, with substituted phenols (preferably alkylphenols or arylphenols), salts of sulphosuccinic esters, taurine derivatives (preferably alkyltaurates), phosphoric esters of polyethoxylated alcohols or phenols, fatty acid esters of polyols, and derivatives of the compounds containing sulphates, sulphonates and phosphates, examples being alkylaryl polyglycol ethers, alkylsulphonates, alkyl sulphates, arylsulphonates, protein hydrolysates, lignin-sulphite waste liquors and methylcellulose. The presence of a surface-active substance is advantageous if one of the active compounds and/or one of the inert carriers is not soluble in water and if application takes place in water.

Further auxiliaries that may be present in the formulations and in the application forms derived from them include colorants such as inorganic pigments, examples being iron oxide, titanium oxide, Prussian Blue, and organic dyes, such as alizarin dyes, azo dyes and metal phthalocyanine dyes, and nutrients and trace nutrients, such as salts of iron, manganese, boron, copper, cobalt, molybdenum and zinc.

Stabilizers, such as low-temperature stabilizers, preservatives, antioxidants, light stabilizers or other agents which improve chemical and/or physical stability may also be present. Additionally present may be foam-formers or defoamers.

Furthermore, the formulations and application forms derived from them may also comprise, as additional auxiliaries, stickers such as carboxymethylcellulose, natural and synthetic polymers in powder, granule or latex form, such as gum arabic, polyvinyl alcohol, polyvinyl acetate, and also natural phospholipids, such as cephalins and lecithins, and synthetic phospholipids. Further possible auxiliaries include mineral and vegetable oils.

There may possibly be further auxiliaries present in the formulations and the application forms derived from them. Examples of such additives include fragrances, protective colloids, binders, adhesives, thickeners, thixotropic substances, penetrants, retention promoters, stabilizers, sequestrants, complexing agents, humectants and spreaders. Generally speaking, the active compounds may be combined with any solid or liquid additive commonly used for formulation purposes.

Suitable retention promoters include all those substances which reduce the dynamic surface tension, such as dioctyl sulphosuccinate, or increase the viscoelasticity, such as hydroxypropylguar polymers, for example.

Suitable penetrants in the present context include all those substances which are typically used in order to enhance the penetration of active agrochemical compounds into plants. Penetrants in this context are defined in that, from the (generally aqueous) application liquor and/or from the spray coating, they are able to penetrate the cuticle of the plant and thereby increase the mobility of the active compounds in the cuticle. This property can be determined using the method described in the literature (Baur et al., 1997, Pesticide Science 51, 131-152). Examples include alcohol alkoxylates such as coconut fatty ethoxylate (10) or isotridecyl ethoxylate (12), fatty acid esters such as rapeseed or soybean oil methyl esters, fatty amine alkoxylates such as tallowamine ethoxylate (15), or ammonium and/or phosphonium salts such as ammonium sulphate or diammonium hydrogen phosphate, for example.

The formulations preferably comprise between 0.00000001% and 98% by weight of active compound or, with particular preference, between 0.01% and 95% by weight of active compound, more preferably between 0.5% and 90% by weight of active compound, based on the weight of the formulation.

The active compound content of the application forms (crop protection products) prepared from the formulations may vary within wide ranges. The active compound concentration of the application forms may be situated typically between 0.00000001% and 95% by weight of active compound, preferably between 0.00001% and 1% by weight, based on the weight of the application form. Application takes place in a customary manner adapted to the application forms.

The following examples are given for purely illustrative and non-limiting purposes of the present invention.

### EXAMPLES

### Example 1: Production of a Flowable, Concentrated Agrochemical Formulation with Fluopyram

Mill Premix and Milling

The following steps provide one embodiment of the method of producing a flowable, concentrated agrochemical formulation:
1. Make a mixture of the desired surfactant (e.g., polymeric surfactant, alkoxylate surfactant, and/or anionic surfactant), structuring agents (e.g., polysaccharide gums, clays, celluloses, polyacrylates, and/or xantham gum), and water.
2. Add most of the water to the mix tank leaving out about 2 to 3 weight % for post addition.
3. Start mixing until all the materials are dissolved, which might take 2-3 hours.
4. Add additional surfactants, and continue mixing until a clear brown solution is produced, which might take 2-3 hours.
5. Add approximately 50% of the fluopyram with continuous stirring. Add in portion to make sure that fluopyram gets proper wetting.
6. Pass the mixture through a colloid mill prior to the media mill (0.6-0.3 mm gap).
7. Add a portion of the anti-foam and continue stirring.
8. Recirculate the mixture through a horizontal media mill (1-1.2 mm diameter glass or ceramic media) until the desired particle size is achieved, and then divert to a final, agitated tank. Alternately, discrete passes may be made through the media mill.
9. Desired particle size: D90-7.00 micron.
   Final Preparation of Flowable, Concentrated Agrochemical Formulation with Fluopyram
1. Slowly add the remaining portion of fluopyram and mix well.
2. Optionally, pass the mixture through a colloid mill prior to the media mill (0.6-0.3 mm gap).
3. Recirculate the mixture through a horizontal media mill (1-1.2 mm diameter glass or ceramic media) until the desired particle size is achieved, and then divert to a final, agitated tank. Alternately, discrete passes may be made through the media mill.
4. Desired particle size: D90-5.50 micron.
5. Add structuring agents (e.g., polysaccharide gums, clays, celluloses, polyacrylates, and/or xantham gum) to deliver the target amount for the final product batch. Mix for at least 30 minutes after the last addition, and then sample for specification limits.
6. Add water and structuring agents to satisfy active ingredient and viscosity specification limits. Mix for at least 30 minutes after the last addition then sample for all specification limits.
7. The rest of the anti-foam may be added to mitigate foam.

Unless defined otherwise, all technical and scientific terms herein have the same meaning as commonly understood by one of ordinary skill in the art to which this invention belongs. All publications, patents, and patent publications cited are incorporated by reference herein in their entirety for all purposes.

It is understood that the disclosed invention is not limited to the particular methodology, protocols and materials described as these can vary. It is also understood that the terminology used herein is for the purposes of describing particular embodiments only and is not intended to limit the scope of the present invention which will be limited only by the appended claims.

Those skilled in the art will recognize, or be able to ascertain using no more than routine experimentation, many equivalents to the specific embodiments of the invention described herein. Such equivalents are intended to be encompassed by the following claims.

1. A method of increasing concentration of an active ingredient in an agrochemical formulation while maintaining flowability of the agrochemical formulation, the method comprising:
i) combining a portion of the active ingredient with a surfactant in water to produce a mixture;
ii) milling the mixture until the particle size of the active ingredient in the mixture is reduced to less than about 100 micrometers; and
iii) adding more of the active ingredient and, optionally, more of the surfactant to the mixture and repeating i) and ii).

2. The method according to claim 1, wherein iii) is performed and, optionally, repeated to achieve successively smaller particle sizes with the active ingredient in the mixture.

3. The method according to claim 1, wherein in ii) the mixture is milled until the particle size of the active ingredient in the mixture is reduced to between about 20 micrometers and about 80 micrometers.

4. The method according to claim 1, wherein in iii) the mixture is milled until the particle size of the active ingredient in the mixture is reduced to less than about 15 micrometers.

5. The method according to claim 4, wherein in iii) the mixture is milled until the particle size of the active ingredient in the mixture is reduced to between about 1 micrometers and about 10 micrometers.

6. The method according to claim 1, wherein the active ingredient has a density of between about 1.0 and about 2.0 g/mL.

7. The method according to claim 1, wherein the active ingredient has a melting point above about 50° C.

8. The method according to claim 1, wherein the active ingredient has a solubility in water of less than about 1000 mg/L.

9. The method according to claim 1, wherein the milling is performed by fluid energy milling, ball milling, wet milling, media milling, high pressure homogenization, or cryogenic milling.

10. The method according to claim 1, wherein the milling is carried out with a media mill, a colloid mill, a planetary mill, a stirred annular mill, a stirred pin mill, a stone mill, a bead mill, or a perforated disc mill.

11. The method according to claim 1, wherein the milling occurs in a mill with a controlled temperature set between about 1° C. and about 60° C.

12. The method according to claim 1, wherein the concentration of the active ingredient in the agrochemical formulation is increased to above 500 g/L.

13. The method according to claim 1, wherein the viscosity of the agrochemical formulation is maintained below 2000 centipoise.

14. The method according to claim 13, wherein the viscosity of the agrochemical formulation is maintained between about 400 centipoise and about 1000 centipoise.

15. The method according to claim 1, wherein the agrochemical formulation is a seed treatment formulation.

16. The method according to claim 1, wherein the active ingredient is an insecticide selected from the group consisting of abamectin, chlorantraniliprole, clothianidin, cyantraniliprole, ethiprole, fipronil, flubendiamide, flupyradifurone, imidacloprid, methiocarb, spinetoram, spinosad, sulfoxaflor, tefluthrin, thiacloprid, thiamethoxam, and thiodicarb.

17. The method according to claim 1, wherein the active ingredient is a fungicide selected from the group consisting of azoxystrobin, beta-cyfluthrin, carbendazim, carbendazim, cyproconazole, epoxiconazole, fenamidone, fluazinam, fludioxinil, fluopyram, fluoxastrobin, fluquinconazole, ipconazole, iprodione, isotianil, metalaxyl, metalaxyl-M, metominostrobin, pencycuron, penflufen, picarbutrazox, picoxystrobin, procymidone, propiconazole, prothioconazole, pyraclostrobin, tebuconazole, triadimenol, and trifloxystrobin.

18. The method according to claim 17, wherein the active ingredient is fluopyram.

19. The method according to claim 1, wherein the active ingredient is a triazole fungicide or a strobilurin fungicide.

20. The method according to claim 1, further comprising determining the concentration of the active ingredient in the agrochemical formulation after milling the mixture in ii) and/or in iii).

21. The method according to claim 1, wherein the surfactant is a nonionic surfactant or an anionic surfactant.

22. The method according to claim 21, wherein the nonionic surfactant is an alkoxylate surfactant or a polymeric surfactant.

23. The method according to claim 22, wherein
the alkoxylate surfactant is an alcohol, alkylphenol, amine, amide, arylphenol, fatty acid or fatty acid ester; and
the alkoxylate surfactant has been alkoxylated with 1 to 50 equivalents.

24. The method according to claim 22, wherein the polymeric surfactant is a block polymer of the A-B or A-B-A type comprising blocks of polyethylene oxide and polypropylene oxide or of the A-B-C type comprising alkanol, polyethylene oxide and polypropylene oxide.

25. The method according to claim 22, wherein the polymeric surfactant is a poloxamer or an acrylic copolymer.

26. The method according to claim 21, wherein the anionic surfactant is a sulfonate or a carboxylate.

27. The method according to claim 26, wherein the sulfonate is a lignin sulfonate, a sulfonate of condensed naphthalenes, or a salt thereof.

28. The method according to claim 26, wherein the carboxylate is an alkyl carboxylate, an alkylphenol ethoxylate, a polycarboxylic acid, or a carboxylated alcohol.

29. An agrochemical formulation produced by the method according to claim 1.

30. The agrochemical formulation according to claim 29, wherein the active ingredient is fluopyram.

31. Propagation material treated with the agrochemical formulation according to claim 29.

32. The propagation material according to claim 31, wherein the propagation material is a seed of corn, soybean, rice, cotton, sugar beet, oil seed rape, sorghum, oat, rye, barley, wheat, sunflower, or a vegetable.

33. The propagation material according to claim 32, wherein the propagation material is a soybean seed.
